(19) United States
(12) Patent Application Publication
(10) Pub. No.: US 2005/0228704 A1
(43) Pub. Date: Oct. 13, 2005

(54) Method of distributing leads to a recipient

(75) Inventors: Eric S. Fishman, Palm Beach Gardens, FL (US); Gregory P. Skillman, North Palm Beach, FL (US)

Correspondence Address: AKERMAN SENTERFITT, P.O. BOX 3188, WEST PALM BEACH, FL, 33402-3188, US

(73) Assignee: 1450, Inc., Palm Beach Gardens, FL (US)

(21) Appl. No.: 10/821,094

(22) Filed: Apr. 8, 2004

(51) Int. Cl. G06F 17/60

(52) U.S. Cl. 705/8

(57) ABSTRACT

A method, a system, and an apparatus for distributing leads to a recipient. The present invention provides a system that distributes leads to recipients based, in part, on their sales history with previous leads and, in part on how expedient a particular recipient is in acting upon a potential lead. As such, the present invention provides a company with control over which recipients may be given a particular lead. The present invention also presents those recipients with a negative sales history the opportunity to improve upon their past performance and, therefore, start receiving more leads.

### BACKGROUND

1. Field of the Invention

The present invention relates to the field of value-added sales and, more particularly, to value-added sales using leads.

2. Description of the Related Art

Modern businesses rely heavily on a wide variety of business strategies to allocate resources, to track the execution of business processes, and to provide an interface for communication with customers, vendors and their own personnel. Business processes executed by a business may be executed across various system boundaries, such as the internet, standard postal mail, and electronic mail.

In the past, customers that were interested in a particular product were forced to visit a store or request product information that was generally delivered via standard postal mail. If the store failed to adequately address the customer's needs or treated the customer poorly, the customer would likely select another store, and potentially purchase a competitor's product. The same result may have occurred if the requested product information were not delivered to the customer on a timely basis.

Modern business strategies have begun to implement the use of toll-free numbers, the internet and company websites as means for customers to contact the company and/or obtain product information and to locate a store that sells the company's products, especially the particular product of interest to the customer. While these strategies have greatly increased a customer's ability to obtain information on an expedited basis, the manufacturer is still unable to ensure that the customer chooses a store or reseller that has a history of treating customers well and/or closing the deal with potential customers or donors.

As a result, some companies have begun using toll-free numbers and their websites as means through which the customer requests information regarding a product line or a particular product and the company then sends this lead to a selected salesperson (either with an internal sales force or an external sales force) or to a selected reseller. The recipient then follows up with the potential customer. However, each recipient, such as a salesperson or reseller, has certain characteristics, including the location of the recipient in relation to the potential customer, the specific product mix they offer, and their history in regards to their performance with previous leads they have been given. This history may include the number of leads they have received in the past, their diligence in following up on the leads, and the direct sales as well as peripheral sales in relation to the direct sale.

As a result, any business with a geographically diverse sales force to whom leads are distributed may encounter difficulties in fairly distributing those leads. In some instances, a lead may be sent directly to one recipient at a time. The recipient then has a period of time in which to respond to the lead or the lead may be pulled and sent to another recipient. However, there is no requirement that the recipient act diligently, and any failure to do so may result in a lost sale.

Other systems send an email to the closest recipient. However, this method fails to take into account that recipient's past history and may cause the customer to look at a competitor's product if the recipient has a poor customer service history or if the reseller sells a variety of brands, only one of which is the manufacturer's.

Still other systems post the lead to a website which various recipients may visit at their convenience, with the first recipient to express an interest receiving the lead. However, while this system does encourage a recipient to access the website continuously, it does not control which recipients may obtain the lead, thereby permitting a recipient with a negative history to obtain leads instead of recipients having a positive history.

Accordingly, it would be beneficial to provide a system for distributing leads that encouraged the recipients to act upon the leads. It would also be beneficial to provide a system for distributing leads that permits the company to have some control over which recipients were awarded a lead. It would also be beneficial to provide a system for distributing leads that rewards recipients based upon their positive history, while also permitting recipients to rectify negative histories.

### SUMMARY OF THE INVENTION

The present invention provides a method, a system, and an apparatus for distributing leads, or more particularly for distributing information concerning a specific entity, to a wide range of recipients. More specifically, the present invention is capable of distributing leads to recipients that gives the sender some control over which recipients may be given a particular lead and which may be used to automatically modify a recipient's ranking, depending upon the recipient's actions, thus modifying the probability that they will be offered future leads. This permits the sender to benefit recipients that have a positive history. The present invention also permits those recipients with a negative history the opportunity to change their history and, therefore, start receiving more leads. Lastly, the system helps encourage recipients to act expeditiously when given a potential lead, which benefits the customer and manufacturer.

In general, the present invention provides a method of distributing leads to recipients. The system receives lead information from a potential customer. Then, the system determines which recipients will be able to win this particular lead. Then, either all possible recipients, or a subset of all possible recipients are chosen. Next, the system generates a link that identifies the lead, the recipient and a trigger. The link is beneficially generated in a manner that is difficult to decipher. Once the link has been created, the link is placed in an email and emailed to the selected recipients. The recipients click on or access the link. The system determines whether the lead has been assigned yet. If not, the system assigns the lead to the recipient that was first to access the link. If the lead has been assigned to another recipient, then the system sends the recipient to another screen that indicates that the lead has already been assigned to another recipient.

More particularly, in one embodiment, the present invention provides a method for distributing leads to a recipient including the steps of receiving a lead from a potential customer; determining a plurality of recipients; generating a link that is placed in an email; and distributing the email to the plurality of recipients; wherein the link is generated such that a first recipient to click on or access the link is assigned the lead.

In another embodiment, the present invention provides a machine-readable storage having stored thereon, a computer program having a plurality of code sections, said code sections executable by a machine for causing the machine to perform the steps of receiving a lead from a potential customer; determining a plurality of recipients; generating a link that is placed in an email; and distributing the email to the plurality of recipients; wherein the link is generated such that a first recipient to access the link is assigned the lead.

In yet another embodiment, the present invention provides a system for distributing leads to a recipient including means for receiving a lead from a potential customer; determining a plurality of recipients; means for generating a link that is placed in an email; and means for distributing the email to the plurality of recipients; wherein the link is generated such that a first recipient to access the link is assigned the lead.

### BRIEF DESCRIPTION OF THE DRAWINGS

There are shown in the drawings, embodiments which are presently used, it being understood, however, that the invention is not limited to the precise arrangements and instrumentalities shown.

FIG. 1 is a flow chart illustrating a method for distributing leads in accordance with the inventive arrangements disclosed herein.

### DETAILED DESCRIPTION OF THE INVENTION

The present invention is more particularly described in the following examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The present invention provides a method, a system, and an apparatus for distributing leads to a recipient. More specifically, the present invention provides a system that distributes leads to recipients based, in part, on their history with previous leads and, in part on how expedient a particular recipient is in acting upon a potential lead. As such, the present invention provides a company with some control over which recipients may be given a particular lead. The present invention also presents those recipients with a negative history the opportunity to improve upon their past performance and, therefore, start receiving more leads. The present invention may be designed to facilitate the processes by which the most appropriate recipients receive the information concerning the potential customer and to facilitate and incentivize appropriate follow-up. These emails may be sent to a variety of different recipients. As used herein, “recipient” or “recipients” may be any person who sells goods or services, such as a direct sales force, a reseller network, a store network, a clerk in a charitable foundation, etc. The information sent concerning a potential customer, a potential donor to a charitable organization, a complaining customer, a customer in need of technical support, or other entity, are all hereinafter collectively referred to as a “lead” or “leads”. As used herein, the term or phrase “receiving a lead” is meant to include the acquisition of a lead by any source such as a written request, a telephone call, an email, access of a website or any other means by which a potential customer requests information from a recipient.

In particular, the system and method of the present invention sends an email to a plurality of recipients at substantially the same time, thereby giving each recipient the opportunity to win a lead. The emails include an link and the first recipient to click on or access the link wins the lead and obtains all of the information associated with the lead either through a subsequent email containing the information or by viewing the information on a website. All subsequent recipients to access the link are informed that they did not, either by being sent another email or by sending them to another website. As used herein “link” is meant to include any means by which the recipient may access the lead information, such as by an active web link that opens a specific website, or by a link that automatically sends the lead information to the recipient via another email, regular mail, facsimile, or other means.

The links that are placed within the emails are designed to be difficult to decode such that a recipient cannot bypass the system and win leads through manipulation of the system. Rather, the present invention contemplates that a recipient will only win the lead by being the first to access the link.

By sending an email all at substantially the same time to a plurality of recipients, the present invention encourages each recipient to regularly check their email and to quickly follow up with leads. As a result, the customer may be contacted quickly, thereby reducing the chance that the customer becomes frustrated by the delay or disinterested in the product. The method and system of the present invention contemplate that the email will be sent simultaneously to each recipient. However, in some embodiments, there may be a slight delay based upon the server through which the email is sent. In one embodiment, it is contemplated that all emails will be sent within one minute to help ensure each recipient has a similar opportunity. However, in other embodiments, the delay between emails may be greater than one minute. These embodiments may be used, for example, to reward recipients with higher ratings by giving them a head start to winning and being assigned the lead.

Also, by sending an email all at one time to a plurality of recipients, the present invention permits a company to select to which recipients they wish to have the email delivered. This enables a company, such as a distributor or manufacturer, to reward those recipients with a positive rating, while also permitting the company to give recipients with a less positive rating another chance to increase their rating.

Each recipient has various characteristics that are taken into account when determining whether a particular recipient will be included in the initial email distribution. These various characteristics may be used in rating each recipient. The characteristics used may include, but are not limited to, the geography or location of the recipient in relation to the potential customer; the product mix sold by the recipient and whether that mix includes the item or items of interest to the customer; their past history in terms of leads they have received in the past; and a combination thereof. The past history of each recipient may include various factors including, but not limited to, the diligence of the recipient; the percentage of leads that resulted in a sale or donation; the percentage of sales that included additional items not originally part of the customer's request; and a combination thereof.

Once these characteristics have been decided, each recipient may then be rated according to a variety of malleable algorithms. Each recipient's rating may be increased or decreased after a lead has been sent to that recipient. Then, when a new lead comes in, the present invention prepares a list of recipients within a reasonable geography to whom the lead may be offered. Each recipient will have their rating noted and the company or distributor who received the lead may then decide as to which recipients should be offered the lead.

Once the company or distributor decides which recipients will receive the lead, the present invention provides that substantially identical emails are sent to each of the selected recipients. These emails do not guarantee that each recipient may win the lead and, therefore, act upon the lead. Rather, these emails simply indicate that a lead is available. The emails may simply include a link. Or the email may include some cursory information, but not sufficient information to enable the recipient to act upon the lead without additional information.

Each recipient to whom the lead is sent is instructed to access a link within the email. The first recipient to access the link effectively “wins” the lead and is provided with all of the information provided by the potential customer. Each subsequent recipient to access the link receives information that the lead has already been distributed.

As such, the present invention uses emails with links to give multiple recipients the opportunity to win a lead based upon the expeditiousness of each recipient. Therefore, as some recipients may have lower ratings than other recipients, they still have the opportunity to win leads and follow-up, thereby permitting those recipients to gradually increase their rating and be included in even more potential emails in the future. At the same time, the system and method of the present encourages recipients with higher ratings to follow-up with leads they win to ensure their ratings do not decline such that they are included in fewer future emails. The ratings may be updated after each lead is sent, or the ratings may be updated periodically, such as on a weekly or monthly basis.

The emails use links to award a lead to the first recipient to click on or otherwise access the link. As such, the emails have a feature in that they are capable of causing the first person to access the link to be sent to a website that includes the lead information, or may be sent an email having the lead information. The feature would also ensure that all other recipients to access the link get sent to another website that indicates that those recipients did not win the lead, or they may be sent an email or otherwise contacted to inform them that they did not win the lead. This feature may be accomplished in a variety of ways.

In one embodiment, the emails each include a secret code that is particular to each recipient. The secret code may be specifically designed for each recipient or, in beneficial embodiments, the secret code is a randomly generated code. The secret code may include letters, numbers, alphanumeric characters, or a combination thereof. The secret code may be any length of characters, although, longer lengths would result in codes that are more difficult to break. In select embodiments, the secret code may be from about 8 to about 12 characters. In other embodiments, the secret code may be a 10 digit number that is randomly generated. No two secret codes are the same between recipients on the same lead, however.

In addition to the secret code, the system and method of the present invention may also use a unique identification (ID) for each recipient. This unique ID is known only by the system and not by the recipient. Then, each recipient ID may be matched with a secret code. In those embodiments wherein the secret code includes at least one number, the recipient ID may be multiplied or otherwise mathematically altered by one or more numeric digits in the secret code. The result of the matching of the ID and the secret code may then be used, or, in an alternative embodiment, this result may be altered, such as by reversing the result.

Once this result has been determined, the system and method of the present invention creates a link that contains the secret code, the matched result of the Unique ID with the secret code, and a lead ID, which is the ID for that particular lead. The links also include a “trigger”. The trigger is a word, phrase or series of characters selected by the company such that when a recipient accesses the link within the email, the trigger lets the program know that this request is coming from an email link.

After the links have been created, an entry is made into an “offerings table” which may be a database table of all leads and includes one or more of the lead ID, the secret code, the matched result of the ID with the secret code and/or the time of the offer. At this point, the company selects, either manually or via an algorithm, which recipients are to have the opportunity to win the lead and the system and method of the present invention sends an email to each of these recipients having the created link placed therein.

Then, once the emails have been sent, the system and method of the present invention await the first recipient to access the link. When the first recipient accesses the link, the trigger lets the program know that a recipient is requesting the information for that lead. The matched result of the ID with the secret code is then unmatched by reversing the process by which the matched result of the ID with the secret code had been created. For example, if the matched result of the ID with the secret code was created by multiplying the ID with a digit in the secret code and then reversed, then the matched result of the ID with the secret code is re-reversed and divided by the digit in the secret code. Then, the database table is checked to determine that the lead ID, the unique ID and the secret code are valid. If they are not valid, then the script terminates. Additionally, in some embodiments, all information regarding the session (the user's IP address, time, information used to simulate the link, etc,) may be recorded and entered into a table and the administrator may be notified, such as via email, about the intrusion.

If the lead ID, the unique ID and the secret code are valid, then the script checks an “accepting table” to see if there are any entries for this particular lead ID. An “accepting table” is a table of those leads that have been accepted. If there are no entries for that particular lead ID, then the recipient's unique ID is entered into this table and that recipient is assigned the lead. At this time, the offerings table is updated with the time the winning recipient responded to the offer. The script then presents the lead data to the winning recipient. In select embodiments, an email is sent to the winning recipient with additional instructions.

When subsequent recipients access the link, the system and method of the present invention performs the same sequence except that when the script checks the accepting table, it will note that there is an entry for that particular lead in the accepting table. As such, the offering table is updated that this particular recipient has accessed the link and the recipient may then be sent to a different website informing them that they did not win the lead. In an alternative embodiment, the recipient may be sent an email indicating that they did not win the link. In yet another embodiment, emails may be sent out to non-winning recipients informing them that another recipient has already won the lead, at which time these non-winning recipients may then ignore the link. In this embodiment, however, the offerings table will not reflect those recipients that are using the system. However, this embodiment does not require a recipient to go through the process of clicking on or accessing a link only to discover they have not won the lead.

In an additional embodiment, and in those embodiments where non-winning recipients access the link and the time and identity of the non-winning recipients is noted, the system and method of the present invention may include a feature that the recipient winning the lead may reject the lead before contacting the potential customer. At that time, the second recipient to access the link may then be obtained from the offerings database and they would be notified that they have now won the lead and the lead information is then sent to them.

The present invention will now be further described through an example. It is to be understood that this example is non-limiting and is presented to provide a better understanding of various embodiments of the present invention.

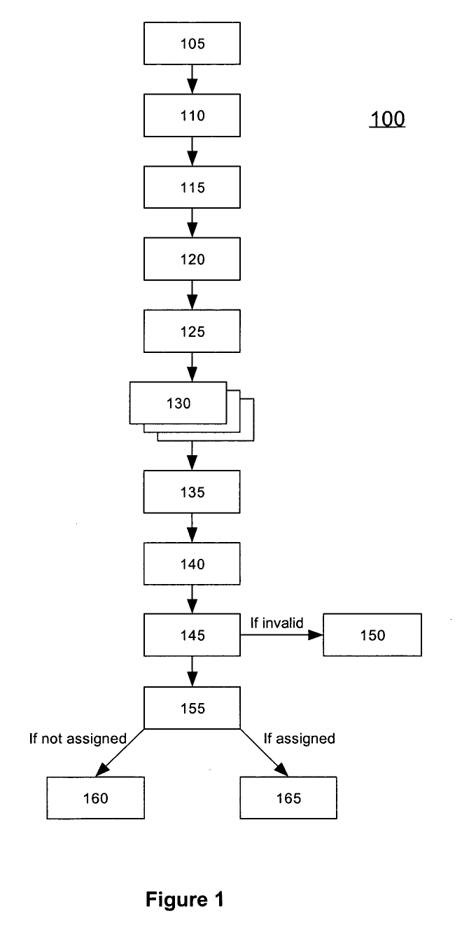

FIG. 1 is a flow chart illustrating a method 100 for distributing leads in accordance with the inventive arrangements disclosed herein. The method 100 may begin in step 105 where the system receives lead information from a potential customer or donor and assigns the lead a lead ID. In step 110, the system determines which recipients will be able to win this particular lead. Then, in step 115, the system generates a secret code, such as a randomly generated 10 digit number. Next, in step 120, the system manipulates each recipient's unique ID with the secret code. In one embodiment, this manipulation includes multiplying each recipient's unique ID by one digit of the secret code and then reversing the result. Then, in step 125, a link that includes the lead ID, the secret code, the multiplied and reversed recipient ID and a trigger is created. The trigger is used such that when the recipient accesses the link within the email, the trigger lets the system know that this request is coming from an email link. In this example, the trigger is “VARLeads=Profit”.

Once the link has been created in step 125, this link is placed in an email and emailed to the selected recipients in step 130. In step 135, the recipients click on or otherwise access the link. In step 140, the system recognizes the trigger and re-reverses the recipient ID and divides by the digit in the secret code to obtain the original recipient ID. In step 145, the lead ID, recipient ID and secret code are compared to the offerings database table to determine if the lead ID, recipient ID and secret code are valid. If not, the system sends the user to step 150 and the script is terminated.

If the lead ID, recipient ID and secret code are valid, then the system proceeds to step 155 wherein the system checks an acceptings database table to determine if the lead ID has been assigned yet. If not, the system proceeds to step 160 wherein the acceptings database table is updated with the recipient's ID and the recipient is then sent the lead information. If the lead ID has been assigned to another recipient, then, in step 165, the system sends the recipient to another screen that indicates that the lead has already been assigned to another recipient.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be placed in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

1. A method of assigning leads to a recipient, the method comprising:
receiving a lead from a potential customer;
determining a plurality of recipients;
generating a link that is placed in an email; and
distributing the email to the plurality of recipients;
wherein the link is generated such that a first recipient to access the link is assigned the lead.

2. The method of claim 1 wherein all subsequent recipients to access the link are notified that the first recipient has been assigned the lead.

3. The method of claim 1, wherein the step of determining a plurality of recipients comprises the steps of:
assigning a rating to each recipient; and
using the assigned ratings to determine a plurality of recipients.

4. The method of claim 3, wherein the step of assigning a rating to each recipient uses an algorithm to determine the rating for each recipient.

5. The method of claim 4, wherein the algorithm uses factors selected from a location of the recipient in relation to the potential customer; a product mix sold by the recipient; a number of leads the recipient has received previously; a diligence of the recipient; a percentage of previous leads that resulted in a sale; a percentage of previous sales that included additional items; and a combination thereof.

6. The method of claim 1, wherein the step of generating the link that is placed in the email comprises the steps of:
assigning a lead identification to the lead;
assigning a unique identification for each of the plurality of recipients;
generating a secret code;
manipulating each unique identification with the secret code; and
adding a trigger.

7. The method of claim 6, wherein the secret code comprises alphanumeric characters.

8. The method of claim 6, wherein the secret code is randomly generated.

9. The method of claim 6, wherein the secret code includes at least one number and each unique identification is manipulated by multiplying each unique identification with a number in the secret code.

10. The method of claim 6, wherein the method assigns the lead to the first recipient to access the link through the steps of:
verifying the trigger;
reversing the step of manipulating each unique identification with the secret code to obtain the unique identification of the first recipient;
comparing the lead identification, the unique identification of the first recipient, and the secret code with a database;
determining whether any unique identification has been associated with the lead identification; and
associating the unique identification of the first recipient with the lead identification if no unique identification has already been associated with the lead identification, thereby assigning the lead to the first recipient.

11. A machine-readable storage having stored thereon, a computer program having a plurality of code sections, said code sections executable by a machine for causing the machine to perform the steps of:
receiving a lead from a potential customer;
determining a plurality of recipients;
generating a link that is placed in an email; and
distributing the email to the plurality of recipients;
wherein the link is generated such that a first recipient to access the link is assigned the lead.

12. The machine-readable storage of claim 11, wherein all subsequent recipients to access the link are notified that the first recipient has been assigned the lead.

13. The machine-readable storage of claim 11, wherein the step of determining a plurality of recipients comprises the steps of:
assigning a rating to each recipient; and
using the assigned ratings to determine a plurality of recipients.

14. The machine-readable storage of claim 13, wherein the step of assigning a rating to each recipient uses an algorithm to determine the rating for each recipient.

15. The machine-readable storage of claim 14, wherein the algorithm uses factors selected from a location of the recipient in relation to the potential customer; a product mix sold by the recipient; a number of leads the recipient has received previously; a diligence of the recipient; a percentage of previous leads that resulted in a sale; a percentage of previous sales that included additional items; and a combination thereof.

16. The machine-readable storage of claim 11, wherein the step of generating the link that is placed in the email comprises the steps of:
assigning a lead identification to the lead;
assigning a unique identification for each of the plurality of recipients;
generating a secret code;
manipulating each unique identification with the secret code; and
adding a trigger.

17. The machine-readable storage of claim 16, wherein the secret code comprises alphanumeric characters.

18. The machine-readable storage of claim 16, wherein the secret code is randomly generated.

19. The machine-readable storage of claim 16, wherein the secret code includes at least one number and each unique identification is manipulated by multiplying each unique identification with a number in the secret code.

20. The machine-readable storage of claim 16, wherein the machine-readable storage assigns the lead to the first recipient to access the link through the steps of:
verifying the trigger;
reversing the step of manipulating each unique identification with the secret code to obtain the unique identification of the first recipient;
comparing the lead identification, the unique identification of the first recipient, and the secret code with a database;
determining whether any unique identification has been associated with the lead identification; and
associating the unique identification of the first recipient with the lead identification if no unique identification has already been associated with the lead identification, thereby assigning the lead to the first recipient.

21. A system of assigning leads to a recipient comprising:
a mechanism for receiving a lead from a potential customer;
a system for determining a plurality of recipients;
a mechanism for generating a link that is placed in an email; and
a distribution mechanism for distributing the email to the plurality of recipients;
wherein the link is generated such that a first recipient to access the link is assigned the lead.

22. The system of claim 22, wherein all subsequent recipients to access the link are notified that the first recipient has been assigned the lead.

23. The system of claim 21, wherein the mechanism for generating the link that is placed in the email comprises:
a system for assigning a lead identification to the lead;
a mechanism for assigning a unique identification for each of the plurality of recipients;
a generating mechanism for generating a secret code;
a mechanism for manipulating each unique identification with the secret code; and
a mechanism for adding a trigger.

24. The system of claim 23, wherein the system assigns the lead to the first recipient to access the link through:
a system for verifying the trigger;
a system for reversing the manipulation of each unique identification with the secret code to obtain the unique identification of the first recipient;
a system for comparing the lead identification, the unique identification of the first recipient, and the secret code with a database;
a determination system for determining whether any unique identification has been associated with the lead identification; and
an association mechanism for associating the unique identification of the first recipient with the lead identification if no unique identification has already been associated with the lead identification, thereby assigning the lead to the first recipient.
